(19) United States
(12) Patent Application Publication
(10) Pub. No.: US 2025/0171956 A1
(43) Pub. Date: May 29, 2025

(54) METHOD AND DEVICE FOR WASTE PAPER PULPING

(71) Applicant: VOITH PATENT GMBH, Heidenheim (DE)

(72) Inventor: Wolfgang MANNES, Volkach (DE)

(21) Appl. No.: 19/037,620

(22) Filed: Jan. 27, 2025

Related U.S. Application Data
(63) Continuation of application No. PCT/EP2023/070390, filed on Jul. 24, 2023.

(30) Foreign Application Priority Data
Jul. 27, 2022 (DE) 10 2022 118 829.9
Jan. 30, 2023 (DE) 10 2023 102 124.9

(51) Int. Cl. D21B 1/32; D21B 1/34

(52) U.S. Cl. CPC D21B 1/32; D21B 1/345

(57) ABSTRACT

A method and a device for pulping fibrous materials is particularly suited for pulping waste paper. The method and the device are especially configured for the pulping of high pulp consistencies of more than 8%. The fibrous materials are added to a horizontally arranged pulper, being a drum or a trough, as a function of a fill level in the pulper. The fill level is measured in the pulper at least at two axially spaced-apart locations in the trough or the drum of the pulper.

### CROSS-REFERENCE TO RELATED APPLICATIONS

This application is a continuation, under 35 U.S.C. § 120, of copending International Patent Application PCT/EP2023/070390, filed Jul. 24, 2023, which designated the United States; this application also claims the priority, under 35 U.S.C. § 119, of German Patent Applications DE 10 2022 118 829.9, filed Jul. 27, 2022, and DE 10 2023 102 124.9, filed Jan. 30, 2023; the prior applications are herewith incorporated by reference in their entirety.

### FIELD AND BACKGROUND OF THE INVENTION

The invention relates to a method for pulping fibrous materials, in particular waste paper, wherein the fibrous materials are supplied to a pulper and mixed with water therein. Drum pulpers and trough pulpers are known as pulpers. In drum pulpers, the drum is rotationally driven and the contents are thus moved. In trough pulpers, the trough is static and the contents are moved by at least one rotor arranged in the trough. Forces are exerted on the solids and liquids located in the pulper by the rotor.

A horizontal drum pulper is known, for example, from European published patent application EP 0 164 428 A1. The drum pulper for waste paper is rotatable around an approximately horizontal axis and is provided with a closed circumferential wall as a soaking drum for mixing water and waste paper and for soaking the waste paper. In the pulping zone, the waste paper admixed with water is pulverized by lifting, slipping, and falling or relative movements of the material components in relation to one another. The pulping process is continuously operated. I.e. fiber suspension is continuously output at the outlet of the drum. A sorting drum having a perforated outer shell is adjacent to the drum pulper. It can also be provided that an outlet-side part of the drum pulper is provided with a perforation, as is known from German Patent Specification DE 25 47 896.

Methods for treating waste paper which operate with a horizontal drum pulper have the advantage of particularly gentle pulping, both with regard to sensitive fiber types and also undesired accompanying substances, which are to be obtained in sortable form. However, the fiber losses are high in the case of fibrous materials which are difficult to dissolve in comparison to fiber pulping by means of a vertical trough pulper. The losses are high in a drum pulper if the shear forces occurring in the drum are not sufficient to pulverize the raw material.

In a continuously operated vertical trough pulper, sufficiently high shear forces are only present in the area of the rotor, which are generally sufficient to tear apart the raw material and render it small enough that it goes through the holes in the screen arranged at the bottom. Following assemblies then also have to take over the further shredding, however. Otherwise, the specks passing through the screen would nonetheless be discharged as rejected material.

Pulpers in the form of a vertical trough pulper having rotors do enable the pulverizing of problematic fibrous materials and other materials, but are aggressive and also destroy the interfering materials. These vertical trough pulpers can be operated continuously and discontinuously. Grinding and pulverization of interfering materials can occur.

For example, a vertical pulper having a trough, in which a control unit is provided, is known from Korean Patent KR 10 0735 656. The fill level and the feed of dilution water are detected and valves can be activated depending on detected data.

A pulper drum is disclosed in Patent Application US 2005/0103453. Detecting the supplied paper material and the water feed is known in the case of the horizontal pulper drum having a pulping section and an adjoining screen section. In addition, the energy used by the drum drive is detected. It is intended that the introduced power per unit of mass be maximized.

Supplying waste paper to a shredder is known from European published patent application EP 1 116 816, wherein the supplied waste paper quantity and supplied water are matched to one another. After the shredding, a dilution to 6% is provided, to subsequently be able to carry out sorting out of interfering materials by wet screening.

### SUMMARY OF THE INVENTION

It is accordingly an object of the invention to provide a waste paper pulping method and device which overcome the above-mentioned and other disadvantages of the heretofore-known devices and methods of this general type and which provides for gentle fiber acquisition with increased efficiency, on the one hand.

It is a particular object of the invention to provide for the gentle and improved shredding of raw materials which are difficult to pulp.

With the above and other objects in view there is provided, in accordance with the invention, a method for pulping fibrous materials, the method comprising:
providing a horizontally arranged pulper;
supplying the fibrous materials to the pulper as a function of a fill level in the pulper;
supplying water to the pulper and controlling a supply of the water as a function of a supply of the fibrous material;
mixing the fibrous material with water in the pulper; and
detecting the fill level in the pulper at at least two axially spaced-apart locations in the pulper.

The fiber supply can be controlled better by determining the fill level height in a horizontally arranged pulper at two (or more) points that are axially spaced apart from one another. More uniform processing of the fibrous material can be achieved by the most uniform possible fill level height in the pulper. In addition, a disruption can be counteracted in the event of an elevated fill level in the rear area by reducing the fiber supply. For example, if the outflow of the suspension is restricted, this disruption can be identified due to the increased fill level, in particular in the pulping zone, and a backup can be counteracted early by reducing or switching off a supply of fibrous material.

In particular, for example, with a reduction of the supply of fibrous material and a reduction of a water supply occurring in relation thereto, it is possible for the consistency of the created fiber suspension to be subject to smaller variations. Such a control is particularly simple. By way of this simple measure, the processing of the fibrous material in the pulper can be subject to smaller variations. Variations of a power consumption of the pulper can be minimized, which also has an advantageous effect on the efficiency of the pulper.

In one preferred embodiment, it is provided that the method is used at material densities of greater than 8%. In particular shear forces present at such material densities have an advantageous effect on the shredding.

The material density is preferably below 20% to operate energy-efficiently. At very high material densities, the time increases in order to wet and soak through the dry input uniformly.

In one preferred embodiment, the method according to the invention is used in a pulper having a U-shaped trough having a horizontally arranged shaft. Fibrous material and water are preferably supplied to an input zone. Due to the use of a pulper having trough, gentle pulping can be achieved with high efficiency. In addition, in a statically arranged trough, adding fibrous material and also water from above is easily possible.

In one preferred embodiment variant, it is provided that in particular the pulping zone is divided into multiple sections. Regulation of water can be provided for each section. Particularly efficient pulping is thus achievable.

In one embodiment variant, it is provided that a supply of water as a function of the fill level height is provided in the input zone and/or the first section. It can thus be ensured that sufficient dilution water is present.

In a particularly preferred embodiment, it is provided that a supply of water takes place as a function of the detected drive power. In particular, an increased amount of water is added for improved pulping with high drive power.

In one method variant, it is provided that, as a function of a detected fill level in the pulper, a supply of fibrous material is interrupted if a predetermined upper limiting value is exceeded, or is at least reduced. In particular, it can be provided that the water supply is also interrupted, but is at least reduced.

Preferably, a supply of fibrous material is restarted only when a fill level at the same measuring position falls below a predetermined lower threshold value. This regulation is particularly uncomplicated.

In one preferred embodiment variant, it is provided that after the supply of fibrous material is switched off, the supply can only be resumed again after a predetermined shutoff time interval. Excessively frequent switching back and forth is thus suppressed. As a minimum time interval, 10 seconds, preferably 15 seconds, has proven to be suitable. Alternatively, it is also possible to work with multiple switching points, for example, two switching points. It can then be provided that it is only started again when the second, lower-lying switching point undershot at all measuring points of the fill level recognition.

In the case of a method which is kept particularly simple, the supply of water is also only provided in the times of supply of fibrous material into the drum. In particular, it is provided that fibrous material and water are always only added together and at the same time.

In a preferred method variant, it is provided that a predetermined amount of water is supplied to supplied fibrous material as a function of the weight of the supplied fibrous material. If a simultaneous addition of water is not possible, water can thus also be added beyond the period of time of the fibrous material supply, so that the predetermined dilution ratio is maintained.

In one embodiment variant, it is provided that the volume of supplied fibrous material is detected. Such a detection can in particular be carried out particularly easily by image recordings. Recordings of an operational monitoring can also be used for this purpose. The inflow of water is regulated as a function of the volumetric amount of supplied fibrous material. Variations in the consistency can thus be reduced in a simple manner. The use of radar sensors for detecting the bulk height has also proven to be particularly suitable.

In a method variant, it is provided that the supply of water is regulated or controlled as a function of a power consumption of the rotor drive. Influence can thus be taken in a simple manner on the concentration of the suspension created in the pulper.

In one preferred embodiment variant, it is provided that different detected fill levels are differentiated as a function of the location of the detected fill level. In particular, in the event of a fill level exceeding a predetermined limiting value detected in the rear area of the pulper and a fill level falling below the predetermined limiting value detected at a front sensor, switching on at least over a predetermined time interval, preferably for a time interval in the range of 5 to 15 seconds, can be provided. Efficient pulping in the front area can thus be ensured in spite of the high fill level, which contributes to increasing the efficiency of the pulper, without risking a disruption. It can be provided that the different detected fill levels, low fill level in front and high fill level in rear, have to be present over a stored minimum period of time before a supply of fibrous material is activated.

With the above and other objects in view there is also provided, in accordance with the invention, a pulper for carrying out the method according to the invention. The novel pulper comprises:
a horizontally arranged drum or horizontally arranged trough and a drive for driving the pulper;
a controller for controlling a supply of water and of fibrous material to said horizontally arranged drum or said horizontally arranged trough;
a sensor system for detecting a fill level at at least two axially spaced-apart locations of said horizontally arranged trough or said horizontally arranged drum for at least one of a control of the supply of fibrous material or a control of the supply of water.

In other words, the pulper is controlled by a controller. The pulper has a rotor and a rotor drive. A discontinuous supply of fibrous material for pulping is provided by the controller. The controller is provided for a discontinuous supply of water and fibrous material. At least two sensors are axially spaced apart from one another in the pulper for a detection of fill levels.

It has proven to be advantageous also to detect the power consumption of the drive and to take it into consideration in the control of the supply of fibrous material and water.

In one preferred embodiment, it is provided that the pulper is provided with a weight detection function and/or volume detection function for detecting the supplied fibrous material. The supply of water can thus take place in a manner matched with the fibrous material. It is thus possible to produce a suspension in a desired consistency more exactly.

In addition, it has proven to be advantageous to provide a water quantity regulation function, so that the water quantity to be added can be added matched to the fibrous material addition. In particular, it has proven to be advantageous to provide a valve in the water supply. Rapid switching over between water supply and no water supply is possible by way of the valve.

It has proven to be advantageous to use the degree of opening of the valve directly as a control element for a control of the supply of water. A more direct control is thus possible. In particular, an interruption of the water supply within 1 to 2 seconds is thus possible.

It has thus also been shown that a constant power consumption of the drive of the rotor or the drum drive assists a continuous pulping process. It has been shown that a continuous power consumption of the rotor is an indication of a uniform material density.

The use of a drum is advantageous for particularly gentle pulping; however an addition of water in a section of a pulping area is not so easily technically implementable. With a static horizontal trough, the addition of water from above is easily possible. The use of a trough is therefore suitable in particular in the case of a section-by-section regulation of a water addition.

Other features which are considered as characteristic for the invention are set forth in the appended claims.

Although the invention is illustrated and described herein as embodied in a method and a device for waste paper pulping, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic representation of an embodiment according to the invention having horizontal trough.

FIG. 2 shows a schematic representation of an embodiment according to the invention having horizontal drum.

### DETAILED DESCRIPTION OF THE INVENTION

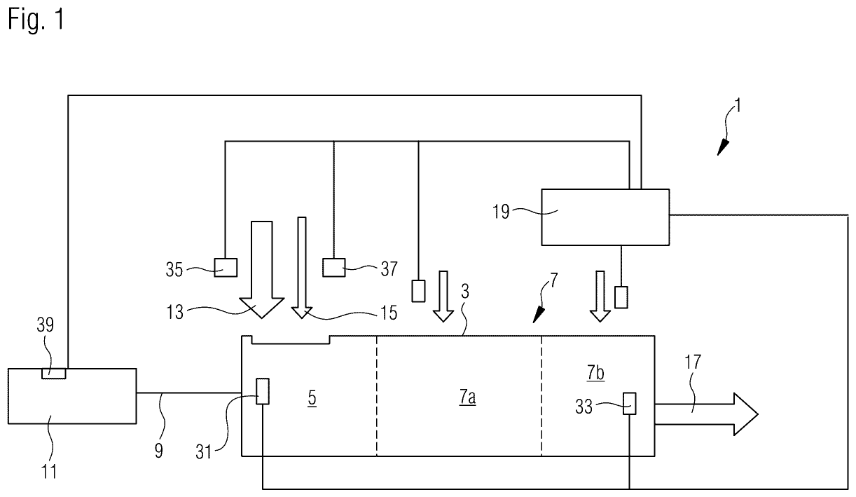

FIG. 1 shows a pulper 1. The pulper has a trough 3 having an inlet zone 5 and a pulping zone 7. Fibrous material and water are mixed in the inlet zone 5. The pulping zone 7 is intended for soaking and pulping fibrous material.

Such pulpers with a trough 3 have an axially extending rotor with rotor shaft 9. A rotor drive 11 is provided for driving the rotor. The power consumption of the rotor drive 11 is detected by a sensor 39 and supplied to an assigned controller 19. In addition, signals of a fill level sensor 31 and a further fill level sensor 33 are supplied to the controller 19. The further fill level sensor 33 is arranged in the pulping zone 7. The further fill level sensor 33 is arranged axially spaced apart from the first fill level sensor 31.

Fibrous material can be supplied to the trough 3 via a waste paper supply 13 and water can be supplied by a supply line 15. A sensor 35 is provided for detecting the fibrous material supply. For example, a camera 35a for a volumetric detection and/or a scale 35b for a detection of weight of the supplied fibrous material or also a detection of volume and weight can be provided as the sensor 35.

In addition to the supply of fibrous material, a supply line for water 15,

also designated as dilution water, is provided. A sensor 37 is assigned to this supply line 15, wherein the flow rate of water in liters per unit of time is detected by the sensor 37. The water quantity can also be determined by summing over time. The sensors 37, 35 have a signal connection to the controller 19.

Predetermined limiting values are stored in the controller 19. The supply of fibrous material and possibly of water is thus controlled as a function of a detected fill level. Control values are stored for this purpose in the controller. It can also be provided that the detected data are compared to the stored data and therefore the control is refined in order to maintain the predetermined values more accurately, such as a predetermined concentration of a created suspension. Different predetermined limiting values and specifications can also be stored for different qualities of fibrous material. The goal is to achieve the most uniform possible concentration of the created fiber suspension, wherein this concentration corresponds to a predetermined value.

If it is provided that the water supply is also reduced to the same extent upon a reduction of the supplied fibrous material and vice versa, even more exact values can thus be achieved. The ratio of fibrous material and water to be supplied can be stored in the controller 19 as a function of different waste paper qualities and desired suspension consistency. In addition, parameters can also be stored in the controller as a function of the fibrous material quality and the desired suspension concentration and the desired degree of processing, which are reflected in the power of the drive of the rotor.

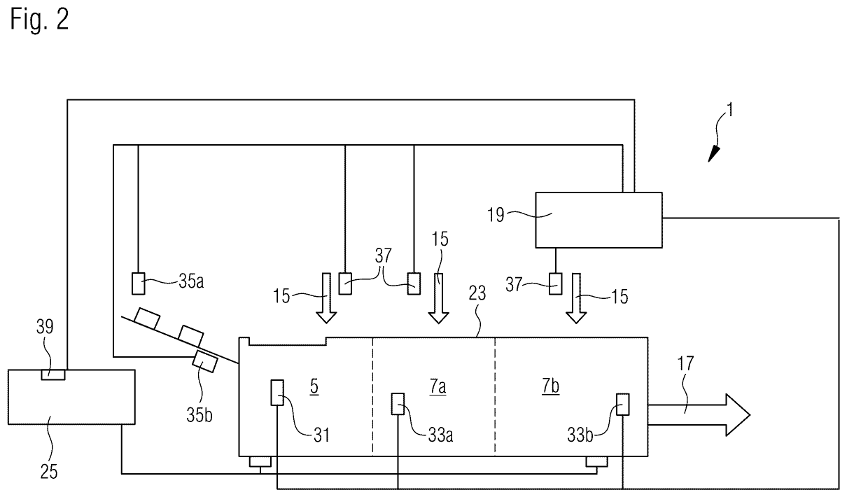

FIG. 2 shows an alternative embodiment of a pulper having a horizontally arranged drum 23. The drum is driven by a drum drive 25. The power consumption of the drum drive 25 is detected by the sensor 39 and fed to the controller 19. In the illustrated embodiment, the drum 23 is shown with an inlet or feed zone 5 and with a pulping zone that is divided into two sections 7a and 7b. Still further sections could also be provided. In the illustrated embodiment, each section 7a and 7b is provided with a separate water supply having assigned sensors 37 for the detection of the supplied dilution water and having sensors with a fill level detection function 33a and 33b for each of the sections. The water supply in the sections 7a, 7b of the drum 23 can be embodiment, for example, by means of a water supply as it is known from European published patent application EP 3 892 773 A1.

The following is a summary list of reference numerals and the corresponding structure used in the above description of the invention:
1 pulper
3 trough
5 inlet zone
7 pulping zone
9 rotor axis
11 drive
13 waste paper supply
15 water supply line
17 fiber suspension
19 controller
23 drum
25 drum drive
31 fill level sensor
33 further fill level sensor
35 fibrous material supply sensor
35a camera
35b scale
37 water supply sensor

1. A method for pulping fibrous materials, the method comprising:
providing a horizontally arranged pulper;
supplying the fibrous materials to the pulper as a function of a fill level in the pulper;
supplying water to the pulper and controlling a supply of the water as a function of a supply of the fibrous material;
mixing the fibrous material with water in the pulper; and
detecting the fill level in the pulper at at least two axially spaced-apart locations in the pulper.

2. The method for pulping fibrous materials according to claim 1, which comprises supplying waste paper and pulping waste paper in the pulper.

3. The method for pulping fibrous materials according to claim 1, which comprises pulping with material densities of greater than 8%.

4. The method according to claim 1, wherein the pulper comprises a trough or a drum divided into an inlet zone and a pulping zone, and wherein the fibrous material and the water are supplied to the inlet zone.

5. The method according to claim 1, wherein the pulping zone is divided into a plurality of sections and the method comprises regulating the supply of dilution water individual for the plurality of sections.

6. The method according to claim 5, which comprises regulating the supply of water as a function of a fill level in at least one of the inlet zone or a front section of the plurality of sections.

7. The method according to claim 5, which comprises regulating the supply of water in a first pulping section disposed axially behind the inlet zone or axially behind the first pulping section as a function of at least one of a drive power of a drive for driving the pulper or a fill level.

8. The method according to claim 1, which comprises interrupting a supply of the fibrous material, as a function of the fill levels detected in the pulper, when a predetermined upper threshold value is exceeded.

9. The method according to claim 1, which comprises supplying a predetermined quantity of water to the fibrous material supplied to the pulper as a function of a weight of the fibrous material supplied to the pulper.

10. The method according to claim 1, which comprises regulating an inflow of water as a function of a volumetric quantity of fibrous material supplied to the pulper.

11. The method according to claim 1, which comprises, when a power consumption of a drive of the pulper falls below a predetermined lower limiting value, performing at least one of the following steps: interrupting the supply of water, or throttling the supply of water, or increasing the supply of fibrous material.

12. The method according to claim 1, which comprises directly using a degree of opening of a valve as a control element for regulating the supply of water.

13. A pulper, comprising:
a horizontally arranged drum or horizontally arranged trough and a drive for driving the pulper;
a controller for controlling a supply of water and of fibrous material to said horizontally arranged drum or said horizontally arranged trough;
a sensor system for detecting a fill level at at least two axially spaced-apart locations of said horizontally arranged trough or said horizontally arranged drum for at least one of a control of the supply of fibrous material or a control of the supply of water.

14. The pulper according to claim 13, wherein said horizontally arranged drum or said horizontally arranged trough has an inlet zone and a pulping zone, and each of said inlet zone and said pulping zone has at least one supply for water.

15. The pulper according to claim 14, wherein said pulping zone is divided at least into a first section and a further section, and wherein a respective supply line for water is provided for each of said first section and said further section.

16. The pulper according to claim 13, comprising a water quantity regulation function for a separate supply of water into individual zones or sections of said horizontally arranged drum or said horizontally arranged trough.
